(19) United States
(12) Patent Application Publication
(10) Pub. No.: US 2024/0289986 A1
(43) Pub. Date: Aug. 29, 2024

(54) INFORMATION PROCESSING DEVICE, INFORMATION PROCESSING METHOD, AND RECORDING MEDIUM

(71) Applicant: CMC Corporation, Aichi (JP)

(72) Inventor: Yukiyasu SASA, Aichi (JP)

(21) Appl. No.: 18/175,268

(22) Filed: Feb. 27, 2023

(51) Int. Cl. G06T 7/80; G06T 11/00

(52) U.S. Cl. CPC G06T 7/80; G06T 11/00; G06T 2200/24; G06T 2207/20101; G06T 2207/30204; G06T 2207/30244

(57) ABSTRACT

An information processing device includes an acquisition unit configured to acquire a recognition result of a space around a target vehicle, a setting unit configured to set, based on the recognition result of the space, positions respectively corresponding to a plurality of predetermined portions of the vehicle in the space as reference points, a specifying unit configured to specify a target position in the space that satisfies a predetermined condition for the positional relationship with each of the plurality of set reference points, and a control unit configured to perform control such that a predetermined virtual object is presented, via a predetermined output unit, in a manner superimposed on the specified target position in the space.

### BACKGROUND OF THE INVENTION

### Field of the Invention

The present disclosure relates to an information processing device, an information processing method, and a recording medium.

### Description of the Related Art

In recent years, as image processing technologies and sensing technologies have improved, various studies have been conducted on a technique that enables a device itself to recognize, by using such technologies, various conditions, and perform processing corresponding to the situation of the moment by using the result of the recognition. In particular, in the field related to vehicles, such as automobiles, due to the market environment that demands improvement in safety and comfort, the realization and spread of vehicles called ASVs (Advanced Safety Vehicles) that apply so-called advanced safety technologies realized by using the aforesaid technologies are being promoted.

In order to maintain the performance of the advanced safety technologies (in other words, to accurately recognize various conditions), it is required that detection devices, such as imaging devices, various radars, various sensors and the like, used to recognize various conditions operate as expected. On the other hand, these detection devices may not operate as expected, for example, when parts are replaced due to failure, when an error occurs in the mounting state due to an accident, or when a maintenance work is performed that changes vehicle height, alignment and/or the like, which may result in deviations in detection results. For such reasons, a so-called calibration work may be performed, at a desired moment, to make the aforesaid detection devices operate as expected. For example, Patent Document 1 discloses an example of a technique related to calibration of various detection devices.
Patent Document 1: Japanese Laid-open Patent Publication No. 2019-7953

As a method for calibrating detection devices installed in a vehicle, there is, for example, a method in which a jig or marker is arranged around a target vehicle such that the jig or marker has a predetermined positional relationship with the vehicle, and then the jig or marker is used as a reference in the calibration of the detection devices. However, such a method tends to complicate the work, as it may require strictly measuring distances around the vehicle, and then arranging a jig or marker at a predetermined position around the vehicle.

### SUMMARY OF THE INVENTION

In view of the above problem, the present invention proposes a technique that makes it possible to simplify the calibration work of detection devices installed in a vehicle.

An information processing device according to an aspect of the present invention includes an acquisition unit configured to acquire a recognition result of a space around a target vehicle, a setting unit configured to set, based on the recognition result of the space, positions respectively corresponding to a plurality of predetermined portions of the vehicle in the space as reference points, a specifying unit configured to specify a target position in the space that satisfies a predetermined condition for the positional relationship with each of the plurality of set reference points, and a control unit configured to perform control such that a predetermined virtual object is presented, via a predetermined output unit, in a manner superimposed on the specified target position in the space.

### BRIEF DESCRIPTION OF THE DRAWINGS

FIG. 1 is a view for explaining an overview of the functions of an information processing device;

FIG. 2 is a view illustrating an example of a UI of the information processing device;

FIG. 3 is a diagram illustrating an example of a hardware configuration of the information processing device;

FIG. 4 is a functional block diagram illustrating an example of a functional configuration of the information processing device;

FIG. 5 is a flowchart illustrating an example of the flow of the processing of the information processing device;

FIG. 6 is a view for explaining a method for specifying a target position according to Example 1;

FIG. 7 is a view for explaining a method for specifying a target position according to Example 2; and

FIG. 8 is a view for explaining a method for specifying target positions according to Example 3.

### DETAILED DESCRIPTION OF THE PREFERRED EMBODIMENTS

A preferred embodiment of the present disclosure will be described in detail below with reference to the accompanying drawings. Note that, in the present specification and the drawings, the components having substantially the same functional configurations are denoted by the same numerals, and the explanation thereof will not be repeated.

### Overview

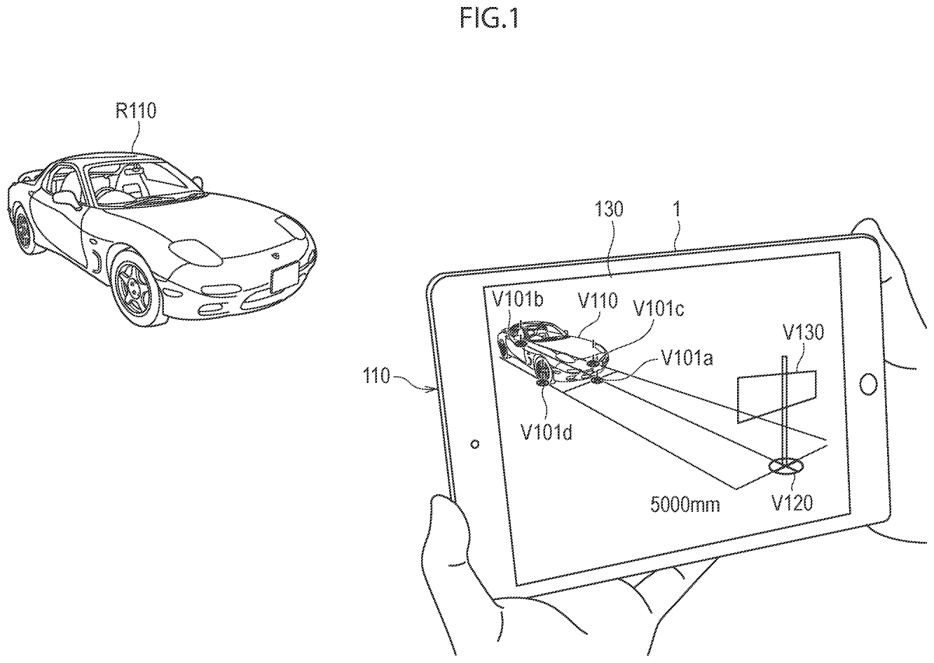

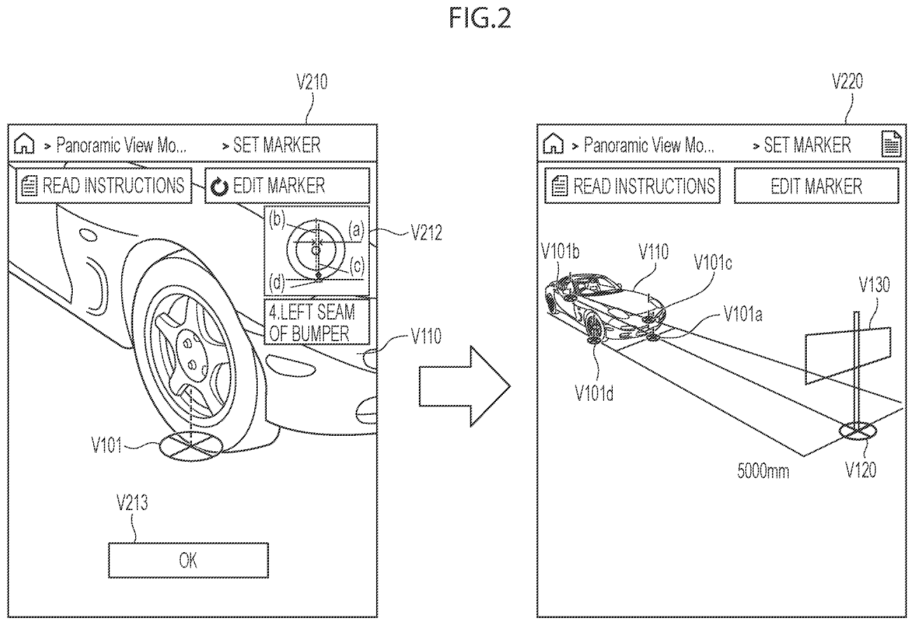

The present disclosure proposes a mechanism to enable a calibration work of detection devices such as imaging devices, various radars, and various sensors used by a vehicle called ASV to realize various advanced safety technologies by a simple procedure. To be specific, an information processing device 1 according to the present embodiment enables, when arranging, around the vehicle, a jig or marker to be used for the calibration of the detection devices installed in the vehicle, a work related to the arrangement of the jig or marker to be realized by a simpler procedure, without complicated procedures such as measuring distances. Therefore, to make the technical features of the information processing device 1 according to the present embodiment easier to understand, an overview of the functions of the information processing device 1 will be described below with reference to FIGS. 1 and 2.

The information processing device 1 according to the present embodiment can be realized, for example, by an information processing device such as a smart phone or tablet terminal provided with an imaging device such as a so-called digital camera and an output device such as a so-called display.

The information processing device 1 presents to a user an image corresponding to an imaging result of a vehicle to be subject to the calibration and the space around the vehicle obtained by a predetermined imaging device. Further, the information processing device 1 recognizes the space (real space) around the vehicle to be subject to the calibration by applying a technique related to the recognition of an object and the surrounding space using detection devices such as imaging devices, various sensors and the like.

Further, the information processing device 1 uses the recognition result of the space around the vehicle to set positions in the space corresponding to each of a plurality of predetermined portions of the vehicle (for example, the center of the front bumper and the like) as reference points, and uses the plurality of set reference points to specify a target position for arranging the jig or marker. Further, the information processing device 1 presents a virtual object corresponding to the aforesaid jig or marker (such as a virtual object that imitate the aforesaid jig or marker, for example) to the user via the aforesaid output device such that the virtual object is superimposed on the target position specified in the space around the aforesaid vehicle. For example, a technology called Augmented Reality (AR) is used to present the aforesaid virtual object.

As a specific example, in an example shown in FIG. 1, a vehicle R110 to be subject to the calibration is imaged from the surroundings by an imaging unit 110 (such as a digital camera, for example) provided in the information processing device 1, and the space around the vehicle R110 is recognized based on the imaging result. Further, an image corresponding to the imaging result of the vehicle R110 and the space around the vehicle R110 obtained by the imaging unit 110 is displayed on an output unit 130 (such as a display, for example) provided in the information processing device 1. The reference numeral V110 indicates the image of the vehicle R110.

In the example shown in FIG. 1, four reference points indicated by reference numerals V101a to V101d are set. For example, the reference point V101a is set as a position corresponding to the front end of the front bumper of the vehicle R110, the reference point V101b is set as a position corresponding to the front end of the rear bumper of the vehicle R110, and the reference points V101c and V101d are set as positions corresponding to the left front wheel and the right front wheel of the vehicle R110.

Note that, in the following description, the reference points V101a to V101d may be referred to simply as “reference points V101” when they are not specifically distinguished.

The number of the reference points to be set and the method for setting the reference points may be changed depending on the type of the detection devices to be subject to the calibration and/or the method of the calibration. An example of conditions for setting the reference points (such as the number of the reference points, the position of the reference points and the like, for example) will be separately described below in detail as examples.

In the example shown in FIG. 1, based on the set reference points V101a to V101d, a position in front of the vehicle R110, separated by a predetermined distance from the front end of the front bumper of the vehicle R110, is specified as a target position V120. Further, in the example shown in FIG. 1, based on AR technology, a virtual object V130, which imitates a jig, is presented in a manner superimposed on the specified target position V120, via the output unit 130. At this time, in accordance with the arrangement condition of the target jig, the display mode of the virtual object V130 that imitates the target jig, such as the posture of the virtual object V130, may be controlled.

Note that the setting of each of the reference points (for example, reference points V101a to V101d) may be performed based on a predetermined instruction from the user, or be performed automatically based on a technique for object recognition and the like.

For example, FIG. 2 shows an example of a UI (User Interface) of the information processing device 1 according to the present embodiment. To be specific, a screen V210 shows an example of a screen for receiving an instruction from the user for designating or editing the reference points. Further, a screen V220 shows an example of a screen related to the presentation of the arrangement position of the jig or marker to be used in the calibration work of the detection devices installed in the vehicle. Note that, among a series of numerals shown in FIG. 2, those identical to the numerals shown in FIG. 1 shall indicate the same objects as indicated by the numerals in FIG. 1.

First, the screen V210 is described below.

The screen V210 displays an image corresponding to the imaging result of the vehicle R110 and the space around the vehicle R110 obtained by the imaging unit 110. Further, when a part of the aforesaid image displayed on screen V210 is designated by a touch operation, for example, the reference points V101 are set at positions in the real space corresponding to the positions in the aforesaid image, and display information (such as a marker, for example) indicating the reference points V101 is displayed in a manner superimposed on the aforesaid image.

At least a part of the reference points V101 may be set automatically by the information processing device 1 based on the recognition result of predetermined portions of the vehicle R110.

The reference points V101 having already been set may be edited (for example, position adjustment and the like) by performing an operation via the screen V210.

In such a case, for example, if the positions of the display information on the aforesaid image corresponding to the reference points V101 displayed in a manner superimposed on the aforesaid image are corrected by performing a drag operation or the like, the positions of the reference points V101 in the real space may be updated corresponding to the positions of the display information after the correction.

Further, notification information V212 indicating the positions and conditions for setting the reference points V101 may be presented on the screen V210. Thus, the user is enabled to perform an operation related to the designation and editing of the corresponding reference points V101 via the screen V210 while confirming the notification information V212.

Thus, when a button V213 is pressed after the operation related to the designation or editing of the reference points V101 is performed via the screen V210, the instruction related to the designation or editing of the reference points V101 based on such operation is confirmed, and the setting of the reference points V101 is updated.

Next, the screen V220 will be described below. As described above, the screen V220 shows an example of the screen related to the presentation of the arrangement position of the jig or marker to be used in the calibration work of the detection devices installed in the vehicle.

Similar to the screen V210, the screen V220 displays an image corresponding to the imaging result of the vehicle R110 and the space around the vehicle R110 obtained by the imaging unit 110. Further, on the screen V220, display information (such as a marker, for example) corresponding to positions each of the series of reference points V101 (the reference points V101a to V101d) previously set and the target position V120 specified based on the series of reference points V101 is displayed in a manner superimposed on each of the series of reference points V101 and the target position V120. In addition, on the screen V220, the virtual object V130 corresponding to the jig or marker is displayed on the aforesaid image in a display mode corresponding to the arrangement condition of the jig or marker (for example, orientation with respect to the vehicle R110) such that the virtual object V130 is superimposed on the aforesaid specified target position V120.

With the aforesaid configuration, the user is enabled to arrange the jig or marker around the target vehicle in accordance with the virtual object presented via the output unit 130 of the information processing device 1, without complicated procedures such as strictly measuring distances. The overview of the functions of the information processing device 1 according to the present embodiment have been described above with reference to FIGS. 1 and 2.

### <Hardware Configuration>

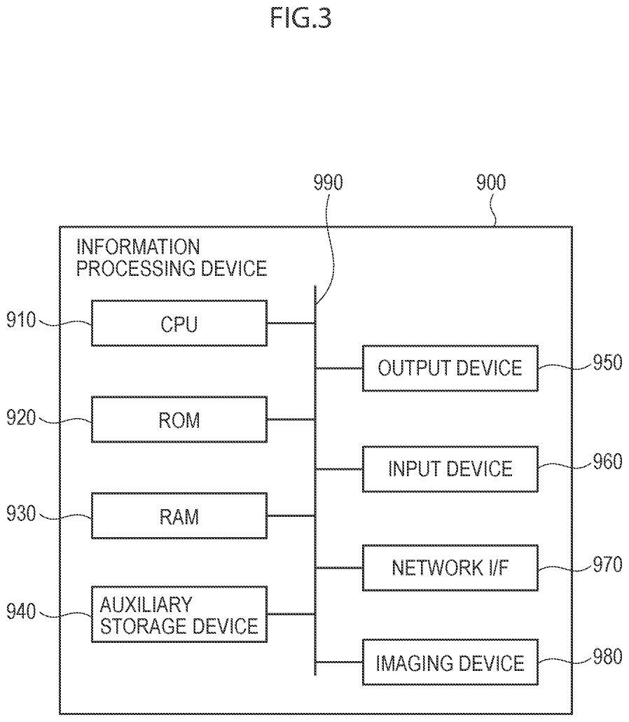

An example of a hardware configuration of a device capable of being applied as the information processing device 1 according to the present embodiment shown in FIG. 1 (hereinafter also referred to as “information processing device 900”) is described below with reference to FIG. 3. The information processing device 900 includes a CPU (Central Processing Unit) 910, a ROM (Read Only Memory) 920, a RAM (Random Access Memory) 930, and an auxiliary storage device 940. The information processing device 900 further includes an output device 950, an input device 960, and an imaging device 980. The information processing device 900 may include a network I/F 970. The CPU 910, the ROM 920, the RAM 930, the auxiliary storage device 940, the output device 950, the input device 960, the network I/F 970, and the imaging device 980 are connected to each other via a bus 990.

The CPU 910 is a central processing unit that controls various operations of the information processing device 900. For example, CPU 910 may control the operation of the entire information processing device 900. The ROM 920 stores a control program, a boot program and the like executable by the CPU 910. The RAM 930 is a main memory of the CPU 910, and is used as a work area or as a temporary storage area for developing various programs.

The auxiliary storage device 940 stores various data and various programs. The auxiliary storage device 940 is realized by a storage device capable of storing various data temporarily or continuously, such as a nonvolatile memory represented by an HDD (Hard Disk Drive), an SSD (Solid State Drive) and the like.

The output device 950 is a device that outputs various information, and is used to present various information to the user. In the present embodiment, the output device 950 is realized by a display device such as a display. The output device 950 presents information to the user by displaying various display information. However, as another example, the output device 950 may be realized by an acoustic output device that outputs sound, such as voice, electronic sound and the like. In such a case, the output device 950 presents information to the user by outputting the sound, such as voice, electronic sound and the like. The device applied as the output device 950 may be changed as appropriate according to the medium used to present information to the user. Note that, the output device 950 corresponds to an example of the “output unit” used to present various information to the user.

The input device 960 is used to receive various instructions from the user. For example, the input device 960 may include an input device such as a mouse, a keyboard, a touch panel and/or the like. The input device 960 may include a sound-collecting device, such as a microphone, to collect the voice spoken by the user.

In such a case, various analysis processes such as acoustic analysis, natural language processing and/or the like are applied to the collected voice, and thereby the content of the voice is recognized as an instruction from the user. The device applied as the input device 960 may be changed as appropriate according to the method for recognizing the instruction from the user. Also, a plurality of types of devices may be applied as the input device 960.

The network I/F 970 is used for performing communication with external devices via a network. Note that the device applied as the network I/F 970 may be changed as appropriate depending on the type of the communication path and the communication method applied.

The imaging device 980 can be realized, for example, by a digital camera having an imaging element such as a CCD (Charge Coupled Device) or a CMOS (Complementary Metal Oxide Semiconductor). The imaging device 980 images a subject and generates an image corresponding to the imaging result.

The program for the information processing device 900 may be provided to the information processing device 900 by a recording medium, such as a CD-ROM, or may be downloaded via a network or the like. When the program of the information processing device 900 is provided by a recording medium, the program recorded on the recording medium is installed in the auxiliary storage device 940 when the recording medium is set in a predetermined drive device.

The configuration shown in FIG. 3 is merely an example and does not necessarily limit the hardware configuration of the information processing device according to the present embodiment. As a specific example, a part of components such as the input device 960, the output device 950, the imaging device 980 and the like may not be included. Also, as another example, configurations corresponding to the functions realized by the information processing device 900 may be added as appropriate.

An example of the hardware configuration of the information processing device 900 that can be applied as the information processing device 1 according to the present embodiment shown in FIG. 1 has been described above with reference to FIG. 3.

### <Functional Configuration>

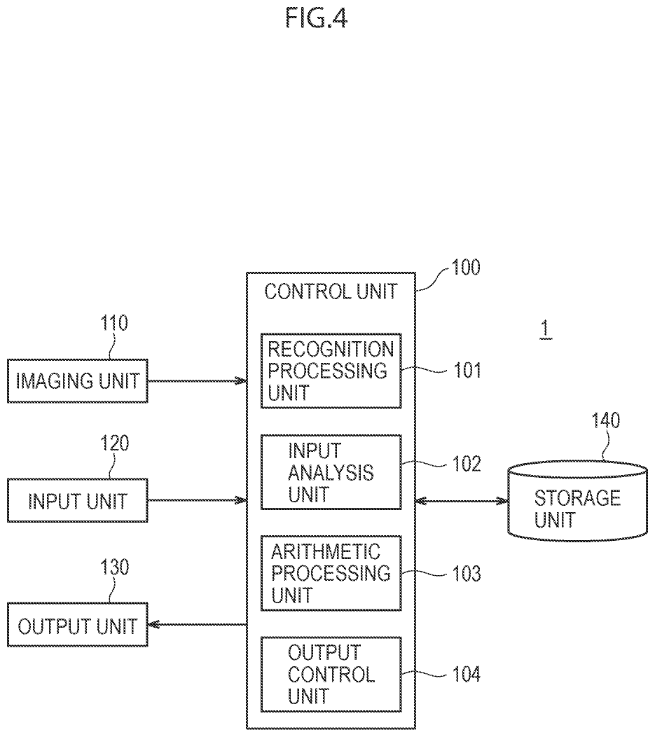

An example of the functional configuration of the information processing device 1 according to the present embodiment will be described below with reference to FIG. 4. The information processing device 1 includes an imaging unit 110, an input unit 120, an output unit 130, a storage unit 140, and a control unit 100.

The imaging unit 110, which corresponds to the imaging unit 110 shown in FIG. 1, captures an optical image within an imaging range, and outputs an image corresponding to the result of the optical image (hereinafter also referred to as “captured image”) to the control unit 100. The imaging unit 110 can be realized, for example, by the imaging device 980 shown in FIG. 3.

The output unit 130, which corresponds to the output unit 130 shown in FIG. 1, presents, under the control of the control unit 100, various information to the user by displaying the information as visible display information on a predetermined display area. As a specific example, the screens V210 and V220 shown in FIG. 2 are presented to the user by being displayed in the predetermined display area by the output unit 130. The output unit 130 can be realized, for example, by the output device 950. As a more specific example, the output unit 130 may be realized by a display device such as a display.

The input unit 120 receives an input from the user and outputs information corresponding to the input to the control unit 100. The input unit 120 can be realized, for example, by the input device 960. As a more specific example, the input unit 120 may be realized by a touch panel that detects a touch operation on the display area where the output unit 130 displays various information.

The storage unit 140 stores various data, programs and the like. The storage unit 140 may be used, for example, as a storage area for storing data and programs for the control unit 100 to perform processing related to the realization of the functions of the information processing device 1. Further, the storage unit 140 may be used as a work area to temporarily hold various data when the control unit 100 executes various processing.

The control unit 100 executes various processing related to the realization of the functions of the information processing device 1. The control unit 100 includes a recognition processing unit 101, an input analysis unit 102, an arithmetic processing unit 103, and an output control unit 104.

The recognition processing unit 101 performs processing related to the recognition of a target space (for example, a real space captured by imaging unit 110) and an object in that space (for example, the vehicle R110 shown in FIG. 1). Note that, if a technique, such as an existing technique, can recognize a target space and an object in that space, such technique may be used without particularly limiting the method and configuration thereof.

As a specific example, the recognition of the target space and the object may be performed based on a plurality of captured images obtained by imaging the target space and the object from a plurality of viewpoints different from each other. In such a case, for example, by acquiring information on the distance between each viewpoint and the subject (in other words, information on depth direction) based on parallax between the captured images corresponding to each of the plurality of viewpoints, the target space may be recognized in three dimensions based on the captured images and the information on the distance.

As another example, the target space may be recognized in three dimensions by recognizing the distance between a target viewpoint (for example, the imaging unit 110) and the subject using a so-called depth sensor such as a TOF (Time of Flight) sensor.

Note that the procedure required to be executed by the user to achieve such recognition may be changed as appropriate depending on the method by which the recognition processing unit 101 recognizes a target real space and an object in that real space.

The recognition processing unit 101 may also perform, according to the recognition method of the target space, processing for associating a relative distance in a recognized logical space (a space as a logical information recognized as the result of an arithmetic operation) with an absolute distance in a real space.

As a specific example, the recognition processing unit 101 may associate a relative distance in a recognized logical space with an absolute distance in a real space by using the recognition result of an object having a known size. As another example, the recognition processing unit 101 may measure an absolute distance toward an object in a target space using a depth sensor or the like, and associate, based on the result of the measurement, a relative distance in a recognized space with an absolute distance in a real space.

Further, the recognition processing unit 101 estimates, based on a technique called self-position estimation, the position of the imaging unit 110, which images the space to be recognized, in that space (in other words, the position of the viewpoint).

As a specific example, the recognition of the target space and the estimation of the position of the viewpoint in that space may be performed based on a technique called SLAM (Simultaneous Localization and Mapping).

Further, the recognition processing unit 101 outputs information corresponding to each of the recognition result of the target space and the object in that space and the estimation result of the position of the imaging unit 110 in that space to the arithmetic processing unit 103 and the output control unit 104.

The input analysis unit 102 recognizes, based on information notified from the input unit 120, an instruction from the user by analyzing the content of an input received from the user by the input unit 120.

As a specific example, the input analysis unit 102 may recognize, based on the information notified from the input unit 120 configured as a touch panel, the position designated by the user by performing a touch operation on a screen displayed in a predetermined display area by the output unit 130, and the type of the touch operation (for example, tap, double tap, drag, and the like). Thus, the input analysis unit 102 is enabled to recognize the instruction from the user for setting or updating the reference points V101, for example, via the screen V210 shown in FIG. 2.

Further, the input analysis unit 102 outputs the information corresponding to the recognition result of the user's instruction to the arithmetic processing unit 103.

The arithmetic processing unit 103 performs various arithmetic operations related to setting the reference points V101 and specifying the target position V120 as described with reference to FIGS. 1 and 2.

As a specific example, the arithmetic processing unit 103 recognizes the content of the instruction from the user based on the information output from the input analysis unit 102, and sets or updates the reference points V101 based on the content of the instruction and the information output from the recognition processing unit 101.

To be more specific, the arithmetic processing unit 103 specifies positions in a target space (real space) corresponding to the positions designated in the image corresponding to the imaging result of the target space obtained by the imaging unit 110, based on the recognition result of the target space and the estimation result of the position of the imaging unit 110 in the target space. For example, the arithmetic processing unit 103 may set, based on the specifying result of the positions in the aforesaid space, new reference points V101 at those positions. As another example, the arithmetic processing unit 103 may update already set positions of the reference points V101 to the positions specified in the aforesaid space.

As further another example, the arithmetic processing unit 103 may acquire, from the recognition processing unit 101, information corresponding to the recognition result of predetermined portions of the target vehicle R110 (for example, the front end of the front bumper and the like), and set the reference points V101 corresponding to those portions based on the acquired information.

Further, the arithmetic processing unit 103 outputs information on each of the series of set or updated reference points V101 (for example, information on the position and the like in the real space) to the output control unit 104. Thus, for example, the output control unit 104 is enabled to display, based on AR technology, the display information (for example, a marker or the like) indicating each of the series of reference points V101 such that the display information is superimposed on the positions set for the reference points V101 in the target space (real space).

The arithmetic processing unit 103 may specify, based on the plurality of set reference points V101, a position in the target space that satisfies a predetermined condition for the positional relationship with each of the plurality of reference points V101, and set the specified position as the target position V120.

Further, the arithmetic processing unit 103 outputs information on the set target position V120 (for example, information on the position in the real space) to the output control unit 104. Thus, for example, the output control unit 104 is enabled to display, based on AR technology, the display information (for example, a marker or the like) indicating the target position V120 such that the display information is superimposed on the target position V120 set in the target space (real space) The output control unit 104 may display, based on AR technology, a predetermined virtual object (for example, the virtual object V130 that imitates a jig) such that the virtual object is superimposed on the target position V120 set in the target space.

The output control unit 104 performs control related to the output of various information via the output unit 130.

For example, the output control unit 104 may notify the user of desired information by having the output unit 130 output predetermined notification information (for example, the notification information V212 shown in FIG. 2).

The output control unit 104 may acquire information on the series of set reference points V101 and the target position V120 from the arithmetic processing unit 103, and control, based on the acquired information, the output unit 130 such that display information corresponding to the reference points V101 and the target position V120 is displayed in a predetermined display area.

At this time, the output control unit 104 may acquire information corresponding to the recognition result of the target space (real space) from the recognition processing unit 101, and control, based on the acquired information, the output unit 130 such that the display information corresponding to the reference points V101 and the target position V120 is displayed in a manner superimposed on the corresponding positions in that space. The output control unit 104 may control the output unit 130 such that a predetermined virtual object (for example, the virtual object V130 corresponding to a jig or marker) is displayed in a manner superimposed on the target position V120 set in the target space (in other words, the target position V120 specified based on the plurality of reference points V101).

Note that the configuration shown in FIG. 4 is merely an example and does not necessarily limit the functional configuration of the information processing device 1 according to the present embodiment. For example, the functional configuration of the information processing device 1 may be realized by the cooperation of a plurality of devices.

As a specific example, a part of the series of components shown in FIG. 4 may be provided in other devices different from the information processing device 1. As a more specific example, at least a part of the components of the imaging unit 110, input unit 120, the output unit 130, and the storage unit 140 may be externally connected to the information processing device 1 as other devices different from the information processing device 1. As another example, a part of a series of elements of the control unit 100 may be provided in other devices different from the information processing device 1.

The load of processing performed by at least a part of the series of elements of the control unit 100 may be distributed among a plurality of devices.

An example of the functional configuration of the information processing device 1 according to the present embodiment has been described above with reference to FIG. 4.

### <Processing>

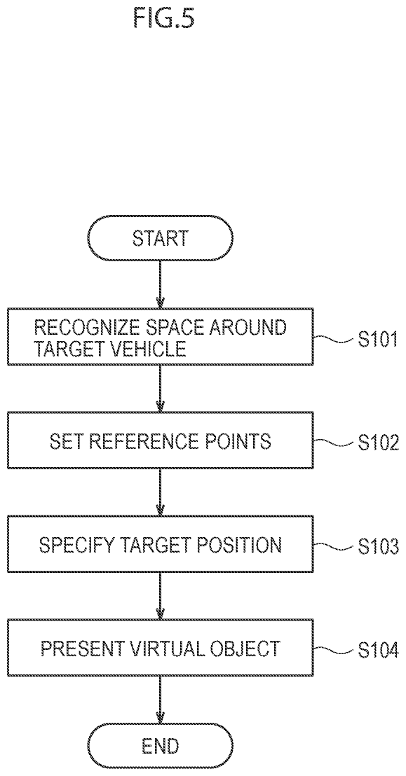

An example of the processing flow of the information processing device 1 according to the present embodiment will be described below with reference to FIG. 5, particularly focusing on the processing related to the realization of the functions described with reference to FIGS. 1 and 2.

In S101, the information processing device 1 executes processing related to the recognition of the space (real space) around the vehicle to be subject to the calibration work of the detection devices. Note that, as described above, if a method enables the information processing device 1 to recognize the target space (i.e., the space around the target vehicle), such method should not be particularly limited, and the procedure required to be executed by the user may be changed as appropriate according to such method. As a specific example, the information processing device 1 may urge, by notifying the user of predetermined information, the user to capture an image of the surroundings of the target vehicle with the imaging unit 110, and recognize the space around the vehicle based on a captured image corresponding to the imaging result.

The information processing device 1 may also recognize the target vehicle. By applying such processing, it becomes possible to use the recognition result of the vehicle in subsequent processing.

In S102, the information processing device 1 sets, according to the type of the vehicle and the detection devices to be subject to the calibration work, a plurality of reference points that serve as references for specifying a position (target position) for arranging the jig or marker to be used in the calibration work. Note that, as described above, if a method can set the reference points corresponding to each of a plurality of predetermined portions of the target vehicle, such method for setting the reference points should not be particularly limited. For example, the information processing device 1 may set, based on an instruction from the user, at least a part of the plurality of the reference points to be set. Further, the information processing device 1 may specify, by using the recognition result of the target vehicle, the positions of the reference points corresponding to the predetermined portions of the vehicle, and set the reference points at the specified positions.

In S103, the information processing device 1 specifies, as a target position, a position in the space around the target vehicle that satisfies a predetermined condition for the positional relationship with each of the plurality of reference points set in S102. Note that the aforesaid condition for specifying the target position may be changed depending on the type of the target detection device and the type of the calibration work for the detection device. As a specific example, each type of vehicle may have a different calibration method for the detection devices. In such a case, the condition for specifying the target position may be set for each type of vehicle designated by the user. Note that information related to the specification of the target position (for example, information on the aforesaid condition or the like) can be stored in a predetermined storage area in advance. The details of the target position setting method will be described later as separate examples.

In S104, the information processing device 1 displays, in a predetermined display area, a virtual object corresponding to a jig or marker to be used in the calibration work of the target detection device such that the virtual object is superimposed on the target position specified in S103 in the space around the target vehicle. At this time, the information processing device 1 may control the display mode of the aforesaid virtual object (such as the posture of the virtual object relative to the vehicle, for example) according to the positional relationship with each of the plurality of reference points set in S102 (by extension, the positional relationship with the target vehicle).

By applying the above control, for example, it becomes possible for the user to arrange a jig or marker to be used in the calibration work in accordance with the virtual object presented in a manner superimposed on the corresponding position in a real space (target position) such that the positional relationship with the target vehicle satisfies the predetermined condition.

To be specific, the user needs to arrange, while confirming the screen displayed on the output unit 130 (such as a display, for example) provided in the information processing device 1, the jig or marker such that it matches the virtual object displayed on the screen. In other words, the information processing device 1 according to the present embodiment can realize the work related to the arrangement of a jig or marker to be used in the calibration work of the detection devices of the target vehicle by a simpler procedure, without complicated procedures such as measuring distances.

An example of the processing flow of the information processing device 1 according to the present embodiment has been described above with reference to FIG. 5, particularly focusing on the processing related to the realization of the functions described with reference to FIGS. 1 and 2.

### EXAMPLES

As examples of the information processing device 1 according to the present embodiment, an example of a method for setting the reference points or the target position depending on the type of the detection device to be subject to calibration work will be described with specific examples.

### Example 1

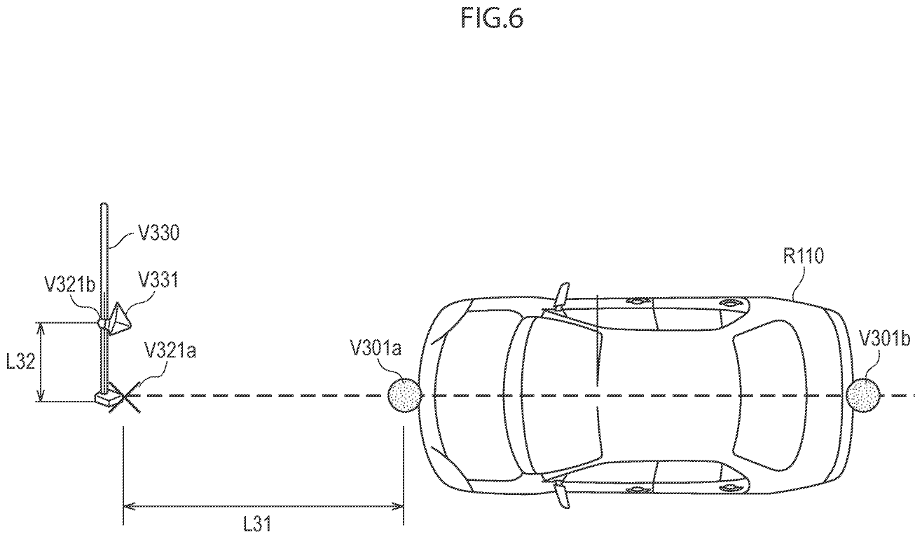

First, as Example 1, an example of a method for specifying a target position for arranging a jig to be used in the calibration work by setting two reference points will be described below with reference to FIG. 6.

FIG. 6 shows an example of a case in which, during a calibration work related to the adjustment of the optical axis of a millimeter wave radar arranged on the front side of the target vehicle, a jig (a reflector for radar optical axis adjustment) is arranged in front of the vehicle. In FIG. 6, the left direction in the drawing corresponds to the front of the vehicle R110, and the right direction in the drawing corresponds to the rear of the vehicle R110. Further, in FIG. 6, the upward direction in the drawing corresponds to the right side of the vehicle R110, and the downward direction in the drawing corresponds to the left side of the vehicle R110.

To be specific, first the information processing device 1 recognizes the floor surface around the vehicle R110 and sets, based on the result of the recognition, a reference plane on which reference points and a target position are to be set.

Next, the information processing device 1 sets two reference points V301a and V301b with respect to the set reference plane.

To be specific, the information processing device 1 sets a position corresponding to the intersection of a straight line extending vertically through the front end of the front bumper of the vehicle R110 and the set reference plane (in other words, the recognized floor surface) as the reference point V301a.

Further, the information processing device 1 sets a position corresponding to the intersection of a straight line extending vertically through the front end of the rear bumper of the vehicle R110 and the set reference plane as the reference point V301b.

Next, the information processing device 1 sets a straight line passing through the reference point V301a with the reference point V301b as the origin, and sets, on the straight line, a position separated by a distance L31 from the reference point V301a toward the opposite side of the reference point V301b as a target position V321a.

Further, the information processing device 1 displays, in a predetermined display area, a virtual object V330 that shows the position and orientation for arranging the jig to be used in the calibration work (for example, a virtual object that imitates the jig) such that the virtual object V330 is superimposed on the set target position V321a.

At this time, the information processing device 1 may control the display of the virtual object V330 such that the vertical position of the reflector for radar optical axis adjustment of the jig corresponding to the virtual object V330 is indicated.

To be specific, the information processing device 1 may set, as the target position V321b, a position separated by a distance L32 from the set target position V321a in the vertical direction. Further, to make a virtual object V331, which imitates a reflector for radar optical axis adjustment, to be presented in a manner superimposed on the set target position V321b, the information processing device 1 may control the display of the virtual object V330 that includes the virtual object V331 as a part thereof.

By performing the above control, the virtual object V330, which imitates the jig (the reflector for radar optical axis adjustment) to be used in the calibration work related to the adjustment of the optical axis of the millimeter wave radar arranged on the front side of the vehicle R110, is displayed in a predetermined positional relationship with the vehicle R110. Note that the example described above is merely an example, and if it is possible to obtain substantially the same result as in the above example, the content of individual processing, the order of processing, and the like are not particularly limited. As a specific example, if it is possible to set each target position such that the result is substantially the same as the above example, a method different from the above example may be applied as the method for specifying the target position. Also, the timing at which each virtual object is generated and displayed, and the timing at which the position and orientation of the virtual object are controlled are not particularly limited.

As Example 1, an example of a method for specifying a target position for arranging a jig to be used in the calibration work by setting two reference points has been described above with reference to FIG. 6.

### Example 2

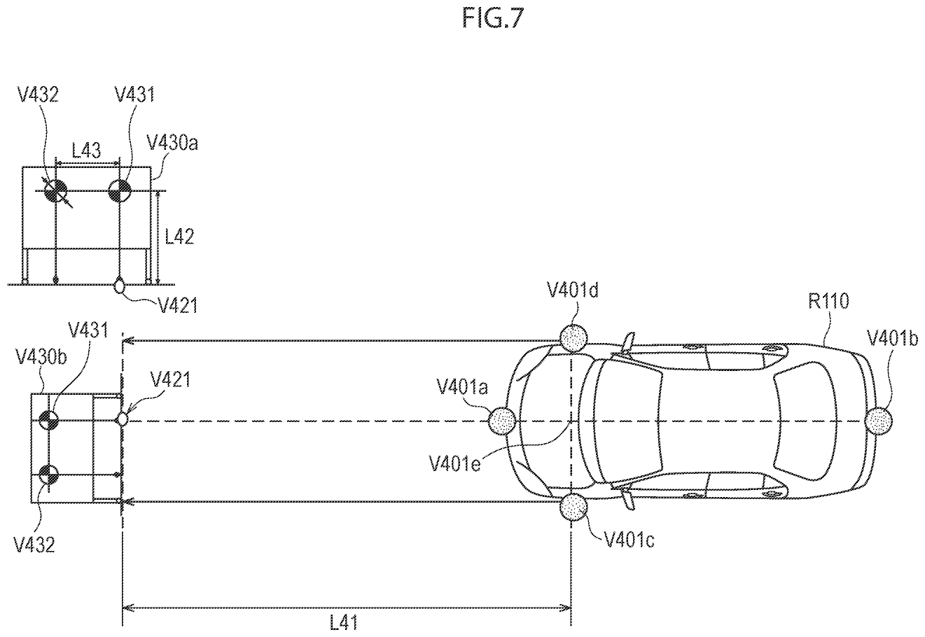

Next, as Example 2, an example of a method for specifying a target position for arranging a jig to be used in the calibration work by setting four reference points will be described below with reference to FIG. 7.

FIG. 7 shows an example of a case in which, during a calibration work related to the adjustment of the optical axis of a camera (front camera) arranged on the front side of a target vehicle, a jig (target for camera optical axis adjustment) is arranged in front of the vehicle. In FIG. 7, the left direction in the drawing corresponds to the front of the vehicle R110, and the right direction in the drawing corresponds to the rear of the vehicle R110. Further, in FIG. 7, the upward direction in the drawing corresponds to the right side of the vehicle R110, and the downward direction in the drawing corresponds to the left side of the vehicle R110.

To be specific, first the information processing device 1 recognizes the floor surface around the vehicle R110 and sets, based on the result of the recognition, a reference plane on which reference points and a target position are to be set.

Next, the information processing device 1 sets four reference points V401a to V401d with respect to the set reference plane.

To be specific, the information processing device 1 sets a position corresponding to the intersection of a straight line extending vertically through the front end of the front bumper of the vehicle R110 and the set reference plane (in other words, the recognized floor surface) as the reference point V401a.

Further, the information processing device 1 sets a position corresponding to the intersection of a straight line extending vertically through the front end of the rear bumper of the vehicle R110 and the set reference plane as the reference point V401b.

Further, the information processing device 1 sets a position corresponding to the intersection of a straight line extending vertically through the center of the surface of the left front wheel of the vehicle R110 and the set reference plane as the reference point V401c.

Further, the information processing device 1 sets a position corresponding to the intersection of a straight line extending vertically through the center of the surface of the right front wheel of the vehicle R110 and the set reference plane as the reference point V401d.

Further, the information processing device 1 specifies an intersection V401e of the line segment connecting the reference points V401a and V401b and the line segment connecting the reference points V401c and V401d.

Next, the information processing device 1 sets a straight line passing through the intersection V401e with the reference point V401b as the origin, and sets, on the straight line, a position separated by a distance L41 from the intersection V401e toward the opposite side of the reference point V401b as a target position V421.

Further, the information processing device 1 displays, in a predetermined display area, a virtual object V430 that indicates the position and orientation for arranging the jig to be used in the calibration work (for example, a virtual object that imitates the jig) such that the virtual object V430 is superimposed on the set target position V421. The reference numeral V430a schematically shows a state of the virtual object V430 as seen from the vehicle R110 side when the virtual object V430 is arranged in a manner superimposed on the target position V421. The reference numeral V430b schematically shows a state in which the virtual object V430 is arranged.

To be specific, the information processing device 1 controls the display of the virtual object V430 such that a marker V431 provided as a part of the virtual object V430 is superimposed on a position separated by a distance L42 from the target position V421 in the vertical direction.

Further, the information processing device 1 sets a straight line that is parallel to the reference plane and orthogonal to the direction in which the straight line passing through the intersection V401e extends with the reference point V401b as the origin. Further, the information processing device 1 controls the display of the virtual object V430 such that a marker V432 provided as a part of the virtual object V430 is superimposed on a position, on the set straight line, separated from the marker V431 by a distance L43 toward the left direction (downward in the drawing) of the vehicle R110.

By performing the above control, the virtual object V430, which imitates the jig (target for camera optical axis adjustment) to be used in the calibration work related to the adjustment of the optical axis of the front camera of the vehicle R110, is displayed in a predetermined positional relationship with the vehicle R110.

As Example 2, an example of a method for specifying a target position for arranging a jig to be used in the calibration work by setting four reference points has been described above with reference to FIG. 7. Note that the example described above is merely an example, and if it is possible to obtain substantially the same result as in the above example, the content of individual processing, the order of processing, and the like are not particularly limited. As a specific example, if it is possible to set each target position such that the result is substantially the same as the above example, a method different from the above example may be applied as the method for specifying the target position. Also, the timing at which each virtual object is generated and displayed, and the timing at which the position and orientation of the virtual object are controlled are not particularly limited.

### Example 3

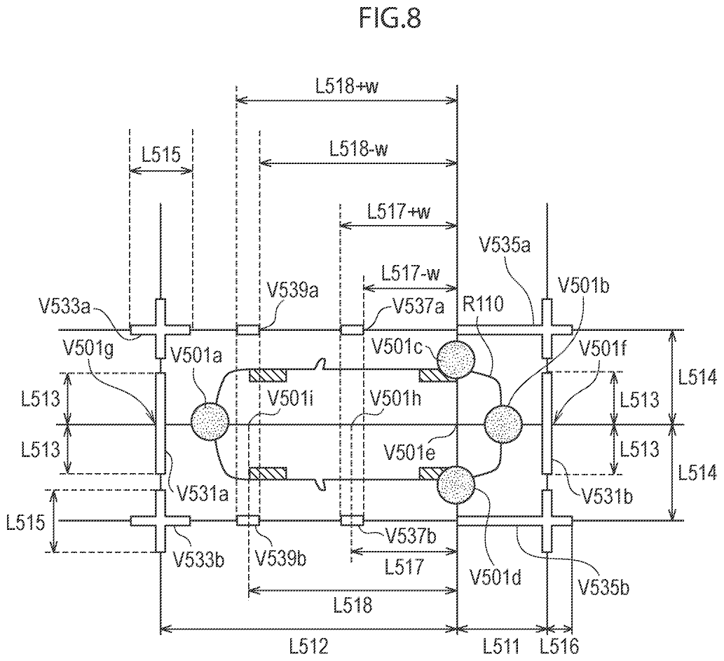

Next, as Example 3, an example of a method for specifying a target position for arranging a marker to be used in the calibration work by setting four reference points will be described below with reference to FIG. 8.

FIG. 8 shows an example of a case in which, during a calibration work related to the adjustment of the optical axis of a camera used to display the situation around a target vehicle on a monitor, a marker is arranged around the vehicle. In FIG. 8, the left direction in the drawing corresponds to the front of the vehicle R110, and the right direction in the drawing corresponds to the rear of the vehicle R110. Further, in FIG. 8, the upward direction in the drawing corresponds to the right side of the vehicle R110, and the downward direction in the drawing corresponds to the left side of the vehicle R110.

To be specific, first the information processing device 1 recognizes the floor surface around the vehicle R110 and sets, based on the result of the recognition, a reference plane on which reference points and target positions are set.

Next, the information processing device 1 sets four reference points V501a to V501d with respect to the set reference plane.

To be specific, the information processing device 1 sets a position corresponding to the intersection of a straight line extending vertically through the front end of the front bumper of the vehicle R110 and the set reference plane (in other words, the recognized floor surface) as the reference point V501a.

Further, the information processing device 1 sets a position corresponding to the intersection of a straight line extending vertically through the front end of the rear bumper of the vehicle R110 and the set reference plane as the reference point V501b.

Further, the information processing device 1 sets a position corresponding to the intersection of a straight line extending vertically through the right end of the rear bumper of the vehicle R110 and the set reference plane as the reference point V501c.

Further, the information processing device 1 sets a position corresponding to the intersection of a straight line extending vertically through the left end of the rear bumper of the vehicle R110 and the set reference plane as the reference point V501d.

Further, the information processing device 1 specifies an intersection V501e of the line segment connecting the reference points V501a and V501b and the line segment connecting the reference points V501c and V501d.

Next, the information processing device 1 sets a straight line passing through the intersection V501e with the reference point V501a as the origin, and sets, on the straight line, a position separated by a distance L511 from the intersection V501e toward the opposite side of the reference point V501a as a target position V501f.

Further, the information processing device 1 displays, in a predetermined display area, a virtual object V531b, which imitates a linear plate that is parallel to the line segment connecting the reference points V501c and V501d and that has a predetermined width extending by a distance L513 to each of the right and left sides of the vehicle R110 with the target position V501f as the center such that the virtual object V531b is superimposed on the target position V501f.

Further, the information processing device 1 sets, on the straight line passing through the intersection V501e with the reference point V501a as the origin, a position separated from the intersection V501e by a distance L512 toward the reference point V501a as a target position V501g.

Further, the information processing device 1 displays, in a predetermined display area, a virtual object V531a, which imitates a linear plate that is parallel to the line segment connecting the reference points V501c and V501d and that has a predetermined width extending by a distance L513 to each of the right and left sides of the vehicle R110 with the target position V501g as the center such that the virtual object V531a is superimposed on the target position V501g.

Further, the information processing device 1 displays, in a predetermined display area, cross-shaped plate-like virtual objects V533a and V533b such that the virtual objects V533a and V533b are superimposed on positions separated by a distance L514 (L514>L513) toward both sides in the direction parallel to the line segment connecting reference points V501c and V501d (i.e., toward the right and left directions of vehicle R110) with the set target position V501g as the center.

Each of the virtual objects V533a and V533b extends, with the position at which the display is superimposed as the center, so as to have a length of L515 in both a direction parallel to the line segment connecting the reference points V501a and V501b and a direction parallel to the line segment connecting the reference points V501c and V501d, and the display is controlled such that the extended portion has a predetermined width.

Further, the information processing device 1 displays, in a predetermined display area, cross-shaped plate-like virtual objects V535a and V535b such that the virtual objects V535a and V535b are superimposed on positions separated by a distance L514 (L514>L513) toward both sides in the direction parallel to the line segment connecting reference points V501c and V501d (i.e., toward the right and left directions of vehicle R110) with the set target position V501f as the center.

Each of the virtual objects V535a and V535b extends, with the position at which the display is superimposed as the center, in both a direction parallel to the line segment connecting the reference points V501a and V501b and a direction parallel to the line segment connecting the reference points V501c and V501d, and the display is controlled such that the extended portion has a predetermined width. At this time, the display is controlled such that the extended portion of each of the virtual objects V535a and V535b in the direction parallel to the line segment connecting the reference points V501c and V501d has a length of L515. Also, the display is controlled such that the extended portion of each of the virtual objects V535a and V535b extending in the direction parallel to the line segment connecting the reference points V501a and V501b is divided into a first part and a second part, with the position at which the display is superimposed as the center, the first part having a length of L511 toward the front side of the vehicle R110, the second part having a length of L516 (L516=L515/2) toward the rear side of the vehicle R110.

The information processing device 1 sets, on the straight line passing through the intersection V501e with the reference point V501a as the origin, a position V501h that is separated from the intersection V501e by a distance L517 (L512>L517) toward the reference point V501a with respect to the intersection V501e.

Further, the information processing device 1 displays, in a predetermined display area, plate-like virtual objects V537a and V537b extending in a direction parallel to the line segment connecting the reference points V501a and V501b such that the virtual objects V537a and V537b are superimposed on positions separated, with the position V501h as the center, by the distance L514 toward both sides in a direction parallel to the line segment connecting the reference points V501c and V501d. At this time, the display is controlled such that the extended portion of each of the virtual objects V537a and V537b extending in the direction parallel to the line segment connecting the reference points V501a and V501b has a length w in each of a front half and a rear half thereof, with the position at which the display is superimposed as the center, and has a predetermined width.

The information processing device 1 sets, on the straight line passing through the intersection V501e with the reference point V501a as the origin, a position V501i that is separated from the intersection V501e by a distance L518 (L512>L518>L517) toward the reference point V501a with respect to the intersection V501e.

Further, the information processing device 1 displays, in a predetermined display area, plate-like virtual objects V539a and V539b extending in a direction parallel to the line segment connecting the reference points V501a and V501b such that the virtual objects V539a and V539b are superimposed on positions separated, with the position V501i as the center, by the distance L514 toward both sides in a direction parallel to the line segment connecting the reference points V501c and V501d. At this time, the display is controlled such that the extended portion of each of the virtual objects V539a and V539b extending in the direction parallel to the line segment connecting the reference points V501a and V501b has a length w in each of a front half and a rear half thereof, with the position at which the display is superimposed as the center, and has a predetermined width.

By performing the above control, the series of virtual objects (i.e., the virtual objects V531a, V531b, V533a, V533b, V535a, V535b, V537a, V537b, V539a, and V539b), which imitate a marker to be used in the calibration work related to the adjustment of the optical axis of a camera used to display the situation around the vehicle R110 on a monitor, are displayed in a predetermined positional relationship with the vehicle R110.

As Example 3, an example of a method for specifying a target position for arranging a marker to be used in calibration work by setting four reference points has been described above with reference to FIG. 8. Note that the example described above is merely an example, and if it is possible to obtain substantially the same result as in the above example, the content of individual processing, the order of processing, and the like are not particularly limited. As a specific example, if it is possible to set each target position such that the result is substantially the same as the above example, a method different from the above example may be applied as the method for specifying the target position. Also, the timing at which each virtual object is generated and displayed, and the timing at which the position and orientation of the virtual object are controlled are not particularly limited.

### CONCLUSION

As described above, the information processing device 1 of the present embodiment acquires a recognition result of a space around a target vehicle, and sets, based on the recognition result of the space, positions respectively corresponding to a plurality of predetermined portions of the vehicle in the space as reference points. Further, the information processing device 1 specifies a target position in the space that satisfies a predetermined condition for the positional relationship with each of the plurality of set reference points, and performs control such that a predetermined virtual object is presented, via a predetermined output unit, in a manner superimposed on the specified target position in the space.

Such a configuration enables, when arranging, around the vehicle, a jig or marker to be used for the calibration of the detection devices installed in the vehicle, a work related to the arrangement of the jig or marker to be realized by a simpler procedure, without complicated procedures such as measuring distances.

The above is merely an example and does not necessarily limit the configuration, control and the like of the information processing device 1 according to the present embodiment. In other words, the configuration, control and the like of the information processing device 1 may be partially modified as long as the modification does not depart from the aforesaid technical concept, which is: setting reference points at positions in a real space corresponding to each of a plurality of portions of the target vehicle, and specifying a target position in the real space based on the plurality of set reference points.

For example, in the embodiment described above, a virtual object is displayed on an image corresponding to an imaging result of the space around the vehicle such that the virtual object is present to the user in a manner superimposed on a desired position in the space. However, the method and the configuration for the method is not particularly limited as long as it is possible to present a virtual object to the user such that the virtual object is superimposed on a desired position in the target space. As a specific example, a transmission type display may be applied as the display device used to present the virtual object. In such a case, the display position of the virtual object in a display area of the transmission type display should be controlled such that the virtual object is superimposed on an optical image of a predetermined space visible to the user through the transmission type display at a desired position in that space.

Although the above description focuses on a calibration work of detection devices installed in a vehicle, the application of the technique according to the present disclosure is not limited hereto. In other words, the technique according to the present disclosure can be applied to any situation as long as a position that satisfies a predetermined condition for the positional relationship with a target object in a real space is specified in such situation. In such a case, the target object is not necessarily limited to a vehicle.

In the foregoing, the present invention has been explained together with an embodiment, but the present invention is not limited only to this embodiment, but can be changed within the scope of the present invention, and the aforesaid embodiment or modifications may be combined as needed.

The present invention also includes a program that realizes the functions of the aforesaid embodiment, and a computer-readable recording medium containing the program.

According to the present invention, it is possible to further simplify a calibration work of detection devices installed in a vehicle.

What is claimed is:

1. An information processing device comprising:
an acquisition unit configured to acquire a recognition result of a space around a target vehicle;
a setting unit configured to set, based on the recognition result of the space, positions respectively corresponding to a plurality of predetermined portions of the vehicle in the space as reference points;
a specifying unit configured to specify a target position in the space that satisfies a predetermined condition for the positional relationship with each of the plurality of set reference points; and
a control unit configured to perform control such that a predetermined virtual object is presented, via a predetermined output unit, in a manner superimposed on the specified target position in the space.

2. The information processing device according to claim 1,
wherein the control unit performs control such that the virtual object is presented in a manner superimposed on the specified target position in the space by displaying the virtual object on an image corresponding to an imaging result of the space obtained by a predetermined imaging unit.

3. The information processing device according to claim 1,
wherein the control unit presents to a user the image corresponding to the imaging result of the space obtained by the predetermined imaging unit via the output unit, and
wherein the setting unit receives designation of positions in the image corresponding to at least a part of the plurality of portions from the user, and sets positions in the space corresponding to the positions in the image as the reference points corresponding to the portions.

4. The information processing device according to claim 2, further comprising the imaging unit.

5. The information processing device according to claim 1,
wherein the acquisition unit acquires a recognition result of at least a part of the plurality of portions, and
wherein the setting unit sets, based on the recognition result of the portions, the positions of the portions in the space as the reference points corresponding to the portions.

6. The information processing device according to claim 1, further comprising the output unit.

7. An information processing method causing a computer to perform processing comprising:
acquiring a recognition result of a space around a target vehicle;
setting, based on the recognition result of the space, positions respectively corresponding to a plurality of predetermined portions of the vehicle in the space as reference points;
specifying a target position in the space that satisfies a predetermined condition for the positional relationship with each of the plurality of set reference points; and
performing control such that a predetermined virtual object is presented, via a predetermined output unit, in a manner superimposed on the specified target position in the space.

8. A recording medium storing a program that causes a computer to perform processing comprising:
acquiring a recognition result of a space around a target vehicle;
setting, based on the recognition result of the space, positions respectively corresponding to a plurality of predetermined portions of the vehicle in the space as reference points;
specifying a target position in the space that satisfies a predetermined condition for the positional relationship with each of the plurality of set reference points; and
performing control such that a predetermined virtual object is presented, via a predetermined output unit, in a manner superimposed on the specified target position in the space.
